(19) United States
(12) Patent Application Publication
(10) Pub. No.: US 2004/0217140 A1
(43) Pub. Date: Nov. 4, 2004

(54) Accessory carrying apparatus

(76) Inventor: Cynthia L. Zola, Tarzana, CA (US)

Correspondence Address: Michael A. Painter, Suite 850, 8484 Wilshire Boulevard, Beverly Hills, CA, 90211, US

(21) Appl. No.: 10/426,181

(22) Filed: May 1, 2003

(51) Int. Cl. B62J 7/06; B60R 7/00; B60R 9/00; B60R 11/00

(52) U.S. Cl. 224/420; 224/572

(57) ABSTRACT

An accessory carrying apparatus adapted to be removably attached to a bicycle, an exercise machine or an ambulatory device such as a wheelchair or a walker. A central flexible panel having opposing first and second surfaces forms the central core of the carrying apparatus. A first peripheral panel is secured to the first surface of the central panel creating one or more pockets to secure therein accessories such as books, a water bottle, exercise gloves and the like. A second peripheral panel is secured to the second surface of said central panel to provide one or more additional pockets for securing additional exercise accessories defined by sizes and shapes different than those provided for by the first peripheral panel. First and second attachment straps are secured to the central panel adjacent openings formed in the first and second peripheral panel. Ends of said attachment straps are provided with means for temporarily securing the attachment straps around the handlebars or the like of a bicycle, exercise machine or a support rail of an ambulatory device.

### BACKGROUND OF THE INVENTION

1. Field of the Invention

The invention generally relates to an apparatus for carrying a user's accessories and, more particularly, an accessory carrying apparatus adapted to be removably affixed to a bicycle, exercise machine or ambulatory device.

2. Prior Art

Due to a variety of factors, there has been an increase in the public's interest in physical fitness, an awareness of environmental issues as well as increased use and need to use bicycles and other ambulatory devices for transportation. Irrespective of whether an individual is using a bicycle for transportation or exercise, fixed apparatus for exercise or has the need for a wheelchair or walker, individuals have found there is no acceptable means for carrying and temporarily storing accessories such as water bottles, books, gloves, or other items which the users require.

One of the most frequently used devices disclosed by the prior art are backpacks. However, backpacks are unacceptable as a result of the inherent way they are used and the structure of same. Firstly, the shape and construction of a backpack preclude the ability to temporarily store flat or other items which can be inadvertently crumpled or otherwise damaged such as paper or magazines. Secondly, when a backpack is used to temporarily store heavy items, its use would impose unacceptable loads on the back and arms of the user. Thirdly, when an individual requires the temporary storage of accessories when exercising or using a walker, a backpack would interfere with the use of the device. The present invention overcomes the inherent inadequacies of backpacks and the like by providing for a carrying apparatus which can be removably affixed to the handlebars of a bicycle or exercise apparatus or support bars of ambulatory devices.

The prior art does disclose carrying apparatus which are adapted to be attached to the handlebars of a bicycle, an exercise machine or an ambulatory device such as a wheelchair or a walker. However, these devices are generally in the form of baskets or other carrying devices which cannot be readily removed. This would preclude the carrying apparatus from being moved by the user for use on another device. This problem is resolved by the present invention since it can be removably secured to the handlebars or other appendage of a bicycle or other device being employed by the user.

The present invention is an improvement over the devices taught by the prior art. The present invention employs a central, flexible panel having opposed surfaces. Peripheral panels are affixed to the opposing surfaces of the central panel in a manner which will permit the user to temporarily store accessories or other items of different sizes and shapes. A pair of attachment straps are affixed to the central panel adjacent the openings formed by the peripheral panels. The attachment straps are provided with temporary securing means such as hook and eye systems (e.g., Velcro®) or the like. The present invention therefore provides the user with a carrying apparatus which can be temporarily or permanently affixed to a bicycle, an exercising machine or an ambulatory device such as a walker.

### SUMMARY OF THE INVENTION

The present invention provides an improved accessory carrying apparatus to be used with bicycles, exercising machines and ambulatory devices such as wheelchairs or walkers. The purpose of the present invention is to provide a carrying apparatus which can be removably secured to devices such as bicycles, exercising machines and the like. A central flexible panel is employed to provide a pair of opposing surfaces. A first peripheral panel is affixed to one surface of the central panel and provides storage pockets for temporarily storing accessories of different sizes and shapes. A second peripheral channel is affixed to the opposing surface of the central panel and provides a storage pocket for temporarily storing accessories which are defined by sizes and shapes different from those secured by the first peripheral channel. A pair of attachment straps are affixed to the central panel adjacent the openings formed by the first and second peripheral channel. Each attachment strap has a first and second end which are adapted to be temporarily secured to one another forming a pair of spaced loops. The attachment straps are adapted to couple the present invention to the handlebars of a bicycle or exercise machine or the support bar of an ambulatory device such as a walker.

The novel features which are believed to be characteristic of the invention, both as to its organization and method of operation, together with further objectives and advantages thereof, will be better understood from the following description considered in connection with the accompanying drawing in which a presently preferred embodiment of the invention is illustrated by way of example. It is to be expressly understood, however, that the drawing is for the purpose of illustration and description only, and is not intended as a definition of the limits of the invention.

### BRIEF DESCRIPTION OF THE DRAWINGS

FIG. 1 is a perspective view of the present invention accessory carrying apparatus attached to an exercise machine.

FIG. 2 illustrates a rear perspective view of the present invention.

FIG. 3 illustrates a front elevation view of the present invention opposed to that shown in FIG. 2.

FIG. 4 illustrates a side elevation view of the present invention showing the attachment straps in the open position.

FIG. 5 illustrates a top plan view of the present invention accessory carrying apparatus.

FIG. 6 illustrates a bottom plan view of the present invention showing the attachment straps in the open position.

FIG. 7 illustrates a front elevation view of an alternative embodiment of a second peripheral panel.

FIG. 8 is a cross-sectional view of the alternative second peripheral panel shown in FIG. 7.

### DESCRIPTION OF THE PRESENTLY PREFERRED EMBODIMENT

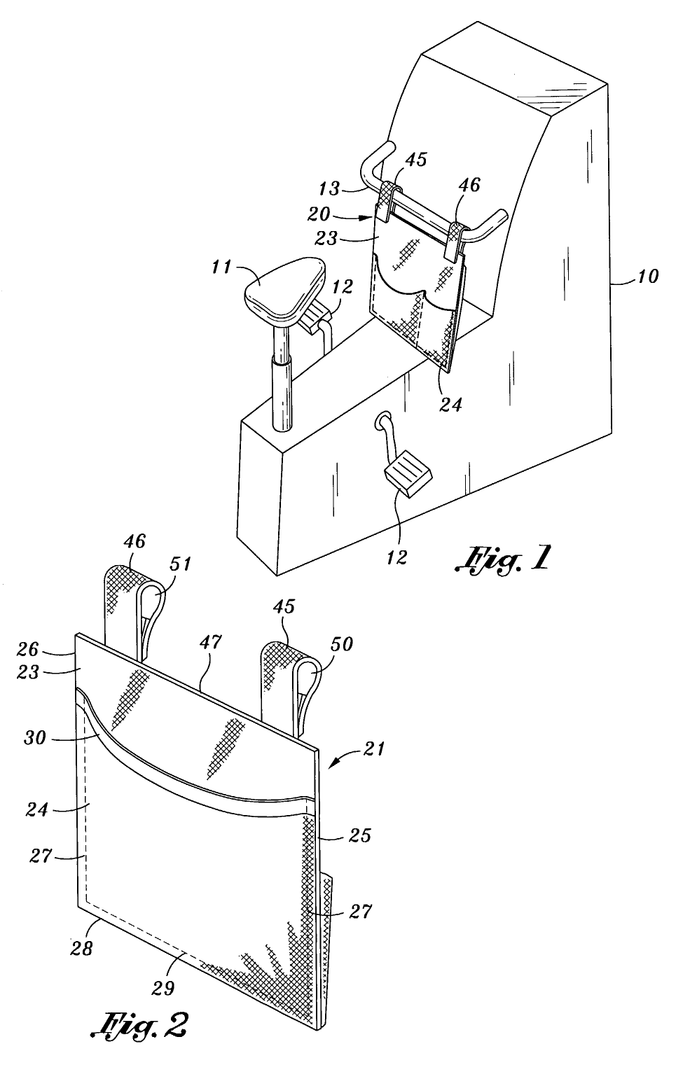

An understanding of the use of the present invention accessory carrying apparatus can be best gained by reference to FIG. 1. As a result of the general public's active interest in physical fitness, environmental issues and the need to use bicycles and other ambulatory devices such as wheelchairs and walkers, it has become well recognized that a need exists to provide means for transporting accessories such as books, water bottles, exercise gloves and the like which can be temporarily affixed to a number of devices. Although it is understood the present invention may be used with a variety of devices such as a bicycle, exercise machine or an ambulatory device, the present invention will be described with respect to its use with an exercising machine 10 as shown in FIG. 1.

Exercise machine 10 constitutes a conventional stationary bicycle used for cardio-vascular exercise. In a manner which is similar to a bicycle, the exercise machine 10 employs an adjustable seat 11 on which the user sits and a pair of pedals 12 for activating machine 10. A structural feature which exercise machine 10 has in common with a bicycle and typical ambulatory devices is a horizontal stabilization bar 13 which allows the user to maintain his or her stability. Stabilization bar 13 is the equivalent of the handlebars of a bicycle or horizontal rails commonly used on ambulatory devices such as wheelchairs and walkers.

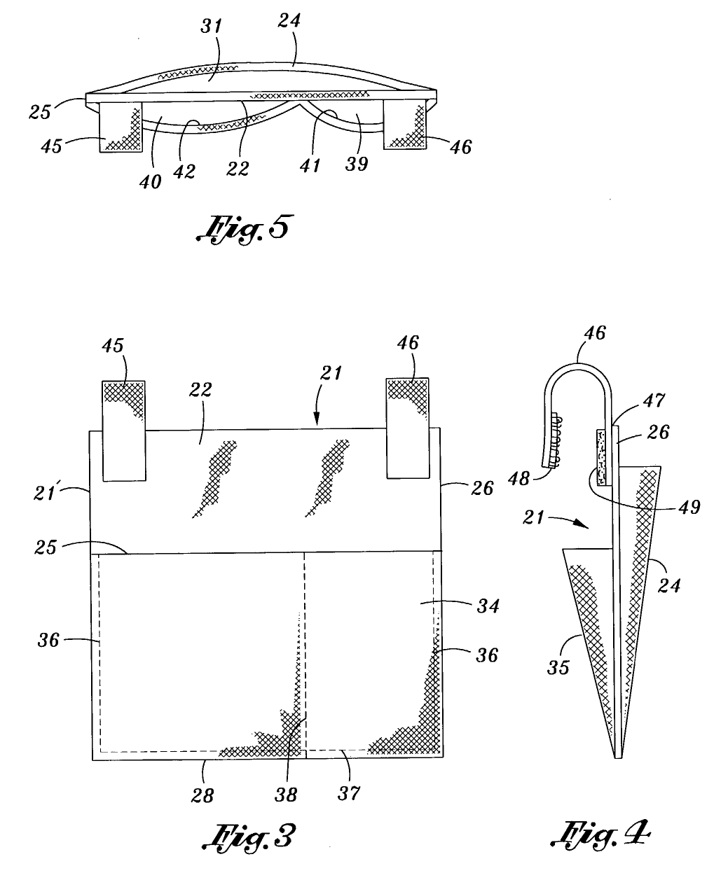

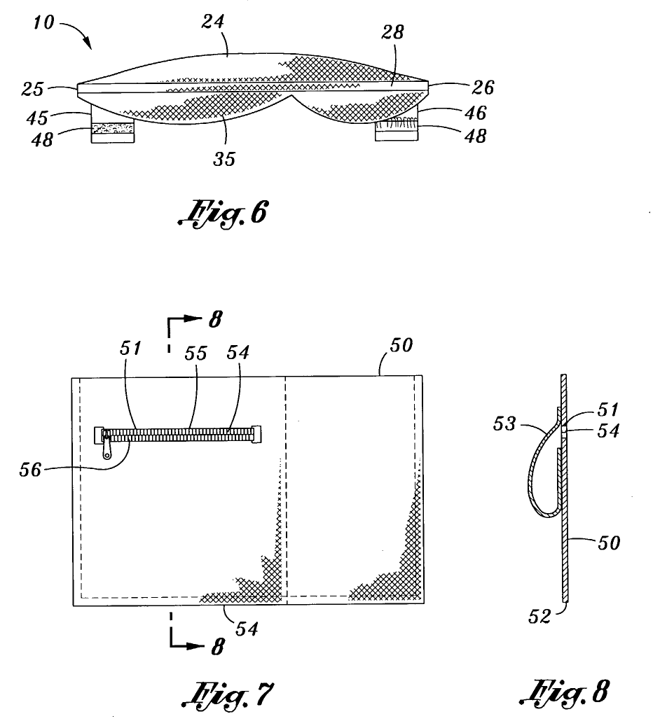

The present invention accessory carrying apparatus 20 is shown in FIG. 1 coupled to stabilization bar 13. An understanding of the structure of accessory carrying apparatus 20 can be best seen by reference to FIGS. 2-6, inclusive. Accessory carrying apparatus 10 comprises a central fabric panel 21 having first and second opposed surfaces 22 and 23 respectively.

As stated, it is an objective of the present invention to provide a carrying apparatus which is capable of temporarily storing accessories of different sizes and shapes. As can be seen best in FIG. 2, a first peripheral panel 24 is coupled to the lateral edges 25 and 26 of central panel 23, preferably by conventional stitching 27. In a like manner, first peripheral panel 24 is coupled to the bottom edge 28 of central panel 23 by stitching 29. The upper terminus 30 of first peripheral panel 24 is greater in length than that affixed to bottom edge 28 thereby forming an opening or pocket 31 (see FIG. 5). The pocket 31 formed between first peripheral panel 24 and second surface 23 of central panel 21 provides means to temporarily store large, flat objects such as notebooks.

To provide for the storage of accessories of larger sizes and shapes, second peripheral panel 34 is coupled to first surface 22. Second peripheral panel 34 is coupled to the lateral edges 25 and 26 of central panel 21 preferably with conventional stitching 36. The bottom terminus of second peripheral panel 34 is coupled to bottom edge 28 of central panel 21 through stitching 37. The upper terminus 38 of second peripheral panel 35 has a length which is greater than that which is coupled to bottom edge 28. To separate stored accessories, at an intermediate and selectable location between lateral edges 25 and 26, second peripheral panel 35 is coupled to central panel 21 by stitching 38 which is in parallel spaced relation to stitching 36. Stitching 36 creates a pair of openings or pockets 39 and 40. Pocket 39 is formed between surface 22 of central panel 24 and sub-surface 41 of second peripheral panel 34. In a like manner, pocket 40 is formed between surface 22 of central panel 24 and interior surface 42 of second peripheral panel 34. It is understood the placement of stitching 38 may be laterally adjusted commensurate with the size and shapes of the accessories to be stored.

An objective of the present invention is to provide an accessory carrying apparatus 20 which can be temporarily secured to a bicycle, exercising machine or the like. To accomplish this objective, the present invention accessory carrying apparatus is provided with attachment straps 45 and 46. Attachment straps 45 and 46 are secured adjacent the upper edge 47 of central panel 23 in juxtaposition to lateral edges 25 and 26, respectively. Attachment straps 45 and 46 each comprise an elongated, flexible panel having securing means at the opposing ends thereof. As can be best seen in FIG. 4, a preferred embodiment of the present invention employs a conventional hook 48 and loop 49 securing system generally identified by the trademark Velcro®. It is understood other conventional temporary securing systems could be employed in lieu thereof. As shown in FIG. 2, when the securing system comprised of hooks 48 and loops 49 are engaged, attachment straps 45 and 46 define enveloping apertures 50 and 51 respectively. As can be seen in FIG. 1, attachment straps 45 and 46 are engaged about stabilization bar 13 which is disposed through apertures 50 and 51, respectively.

An alternative embodiment of the present invention can be best gained by reference to FIGS. 7 and 8 which illustrate an alternative structure for a second peripheral panel which is generally designated by the reference numeral 50. As stated hereinabove, it is an objective of the present invention to provide an apparatus for securing accessories defined by their different shapes and sizes. Another objective met by the alternative embodiment of the present invention provides an auxiliary pocket to secure valuable items such as keys, money and the like. The alternative embodiment of the present invention is described with respect to a modification to second peripheral panel 50. It will be understood by persons having skill in the art that first peripheral panel 24 could be modified accordingly. Second peripheral panel 50 is modified to secure valuable items such as money and keys. An aperture 51 is disposed through a segment of second peripheral panel in parallel spaced relation to bottom edge 52. An enclosing structure or pocket 53 having an opening is secured to second peripheral panel 50 about aperture 51. A zipper 54 is secured to the upper and lower margins 55 and 56 to enclose pocket 53 and maintain the security of the objects placed therein. It is understood other conventional closing means such as engaging snaps, buttons or Velcro® could be used in place of zipper 54.

The present invention provides an improved apparatus which permits the user to carry accessories while using a bicycle, exercising machine or a related ambulatory device. Not only can the user temporarily carry and store accessories of different sizes and shapes, it can be moved from device to device.

I claim:

1. An accessory carrying apparatus for use with a support member comprising:
(a) a planar central panel having opposed first and second surfaces and top, bottom and lateral edges;
(b) a first peripheral panel having top, bottom and lateral edges, the length of the top edge being greater than the length of the bottom edge thereof, the top and lateral edges of said first peripheral panel being secured to the first surface of said central panel at the bottom and lateral edges, respectively;
(c) a second peripheral panel having top, bottom and lateral edges, the length of the top edge being greater than length of the bottom edge thereof, the bottom and lateral edges of said second peripheral panel being secured to the second surface of said central panel at the bottom and lateral edges, respectively; and
(d) attachment means for removably coupling said accessory carrying apparatus to the support member, said means being secured to the top edge of said central panel.

2. An accessory carrying apparatus as defined in claim 1 wherein said central panel and said first and second peripheral panels are flexible fabric.

3. An accessory carrying apparatus as defined in claim 1 wherein said second peripheral panel is secured to the second surface of said central panel intermediate the lateral edges thereof.

4. An accessory carrying apparatus as defined in claim 1 wherein said attachment means comprises first and second elongated attachment straps each having a fixed end and a moveable end, the fixed end of each attachment strap being secured to the central panel at the top edge thereof adjacent an opposed lateral edge, means for securing said attachment straps being coupled to the fixed and moveable end of each attachment strap respectively.

5. An accessory carrying apparatus as defined in claim 1 wherein said second peripheral panel includes an aperture therethrough parallel and in spaced relation to the bottom lateral edge thereof, an auxiliary pocket being secured about said aperture in said second peripheral panel, closure means being secured along the aperture in said second peripheral panel for securing accessories within said auxiliary pocket.
